(19) United States
(12) Patent Application Publication
(10) Pub. No.: US 2024/0260498 A1
(43) Pub. Date: Aug. 8, 2024

(54) AGRICULTURAL SYSTEM AND METHOD FOR MONITORING FIELD CONDITIONS OF A FIELD

(71) Applicant: CNH Industrial Canada, Ltd., Saskatoon (CA)

(72) Inventor: James W. Henry, Saskatoon (CA)

(21) Appl. No.: 18/107,323

(22) Filed: Feb. 8, 2023

(51) Int. Cl. A01B 76/00; A01B 15/02; A01B 79/00

(52) U.S. Cl. CPC A01B 76/00; A01B 15/02; A01B 79/005

(57) ABSTRACT

An agricultural system for monitoring field conditions of a field after an agricultural operation in the field includes an agricultural implement having a frame and ground-engaging tools supported on the frame, with the ground-engaging tools being configured to engage the field during the agricultural operation. The agricultural system further includes a sensor supported on the agricultural implement, where the sensor has a field of view directed towards an aft portion of the field disposed rearward of the agricultural implement relative to a direction of travel, with the sensor being configured to generate data indicative of a field condition associated with the aft portion of the field. Additionally, the agricultural system includes an actuator configured to selectively move the sensor relative to the agricultural implement such that the field of view of the sensor moves along the direction of travel relative to an aft end of the agricultural implement.

### FIELD OF THE INVENTION

The present disclosure relates generally to agricultural implements and, more particularly, to agricultural systems and methods for monitoring field conditions of a field after an agricultural operation of an agricultural implement within the field.

### BACKGROUND OF THE INVENTION

It is well known that, to attain the best agricultural performance from a field, a farmer must cultivate the soil, typically through a tillage operation. Tillage implements typically include a plurality of ground engaging tools configured to engage the soil as the implement is moved across the field. Such ground engaging tool(s) loosen and/or otherwise agitate the soil to a certain depth in the field to prepare the field for subsequent agricultural operations, such as planting operations.

When performing a tillage operation, it is desirable to create a level and uniform layer of tilled soil across the field to form a proper seedbed in subsequent planting operations. Depending on the season, different surface finishes may be desired. For instance, rougher surfaces with more and/or larger clods may be desired when tilling before wintering a field, as the surface will become smoother over winter and be ready for spring planting, whereas a smoother field may crust over during wintering, which requires another tillage pass before spring planting to break up the crust. However, the soil type or texture, the amount and distribution of crop residue, the moisture content, and/or the like may vary across a field, which requires an operator to constantly monitor the surface finish created during passes with the implement during the agricultural operation and make frequent adjustments to the implement to maintain the proper surface finish. Further, if the implement is creating a dust cloud, it may be difficult for an operator to see the field directly behind the implement. If the proper surface finish is not maintained, additional passes in the field may be required, which increases costs and time, and may even reduce the yield of the next planting within the field.

Accordingly, an agricultural system and method for monitoring field conditions of a field after the performance of an agricultural operation within the field would be welcomed in the technology.

### BRIEF DESCRIPTION OF THE INVENTION

Aspects and advantages of the invention will be set forth in part in the following description, or may be obvious from the description, or may be learned through practice of the invention.

In one aspect, the present subject matter is directed to an agricultural system for monitoring field conditions of a field after an agricultural operation in the field. The agricultural system may include an agricultural implement having a frame and ground-engaging tools supported on the frame, with the ground-engaging tools being configured to engage a field during an agricultural operation. The agricultural system may further include a sensor supported on the agricultural implement, where the sensor may have a field of view directed towards an aft portion of the field disposed rearward of the agricultural implement relative to a direction of travel of the agricultural implement, and where the sensor may be configured to generate data indicative of a field condition associated with the aft portion of the field. Additionally, the agricultural system may include an actuator configured to selectively move the sensor relative to the agricultural implement such that the field of view of the sensor moves along the direction of travel relative to an aft end of the agricultural implement.

In another aspect, the present subject matter is directed to an agricultural method for monitoring field conditions of a field after an agricultural operation with an agricultural implement in the field, where the agricultural implement may have a frame and ground-engaging tools supported on the frame, and where the ground-engaging tools may be configured to engage a field during the agricultural operation. The agricultural method may include receiving, with a computing system, data generated by a sensor supported on the agricultural implement, with the sensor having a field of view directed towards an aft portion of the field disposed rearward of the agricultural implement relative to a direction of travel of the agricultural implement, where the data may be indicative of a field condition associated with the aft portion of the field. The agricultural method may further include determining, with the computing system, whether the aft portion of the field is obscured based at least in part on the data generated by the sensor. Additionally, the agricultural method may include controlling, with the computing system, an operation of an actuator to move the sensor relative to the agricultural implement when the aft portion of the field is obscured such that the field of view of the sensor moves along the direction of travel relative to an aft end of the agricultural implement.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 illustrates a perspective view of one embodiment of a tillage implement coupled to a work vehicle in accordance with aspects of the present subject matter, particularly illustrating a sensor having a field of view directed towards an aft portion of the field;

FIG. 2 illustrates another perspective view of the implement shown in FIG. 1, particularly illustrating various components of the implement in accordance with aspects of the present subject matter:

FIGS. 3A-3B illustrate schematic side views of the implement shown in FIGS. 1 and 2, particularly illustrating the sensor being linearly actuated between a first position and a second position:

FIGS. 4A-4B illustrate schematic side views of the implement shown in FIGS. 1 and 2, particularly illustrating the sensor being rotatably actuated between a first position and a second position:

FIGS. 5A-5B illustrate schematic side views of the implement shown in FIGS. 1 and 2, particularly illustrating another example of the sensor being rotated between a first position and a second position:

FIG. 6 illustrates a schematic view of a system for monitoring field conditions of a field after an agricultural operation in the field in accordance with aspects of the present subject matter; and

FIG. 7 illustrates a flow diagram of one embodiment of a method for monitoring field conditions of a field after an agricultural operation in the field in accordance with aspects of the present subject matter.

Repeat use of reference characters in the present specification and drawings is intended to represent the same or analogous features or elements of the present technology.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

In general, the present subject matter is directed to agricultural systems and methods for monitoring field conditions of a field after an agricultural operation in the field. Specifically, the disclosed system may include an agricultural implement having at least one ground engaging tool (e.g., a shank, a disc blade, a leveling blade, a tine, a basket assembly, and/or the like) configured to engage and work a field during the agricultural operation. The system may further include a sensor (e.g., a camera, a LIDAR sensor, etc.) having a field of view directed towards an aft portion of the field disposed rearward of the agricultural implement relative to a direction of travel of the agricultural implement, the aft portion of the field having just been worked by the agricultural implement, the sensor being configured to generate data indicative of a field condition associated with the aft portion of the field. Certain types of vision-based sensors cannot fully penetrate through obstructions such as dust, fog, or rain, such that the surface of the field may be obscured or obstructed to the sensor during such conditions. Thus, in accordance with aspects of the present subject matter, the system may additionally include an actuator configured to selectively move the sensor relative to the agricultural implement such that the field of view of the sensor moves along the direction of travel relative to an aft end of the agricultural implement. As such, when it is determined that the aft portion of the field is obscured from view by a dust cloud and/or the like, the actuator may be controlled to move the sensor such that the field of view of the sensor is re-directed to avoid the obstruction (e.g., dust cloud).

Particularly, in some instances, a controller of the disclosed system may be configured to automatically determine that the aft portion of the field is obscured from view by a dust cloud and/or the like between the aft portion of the field and the sensor based at least in part on the data generated by the sensor, then the controller may recommend to an operator that the sensor be moved and/or the controller may automatically control the operation of the actuator to move the sensor. However, in some instances, the controller may be configured to control a user interface to display the aft portion of the field based on the data generated by the sensor and, in response, receive an input from an operator indicating that the aft portion of the field is obscured and/or a request that the operation of the actuator be controlled to move the sensor. Accordingly, the field conditions of a field after the performance of an agricultural operation by an agricultural implement within the field may be monitored with less interruption by obstructions (e.g., dust clouds), which leads to better control of the agricultural implement during the agricultural operation, and therefore, reduces costs and time to perform the agricultural operation.

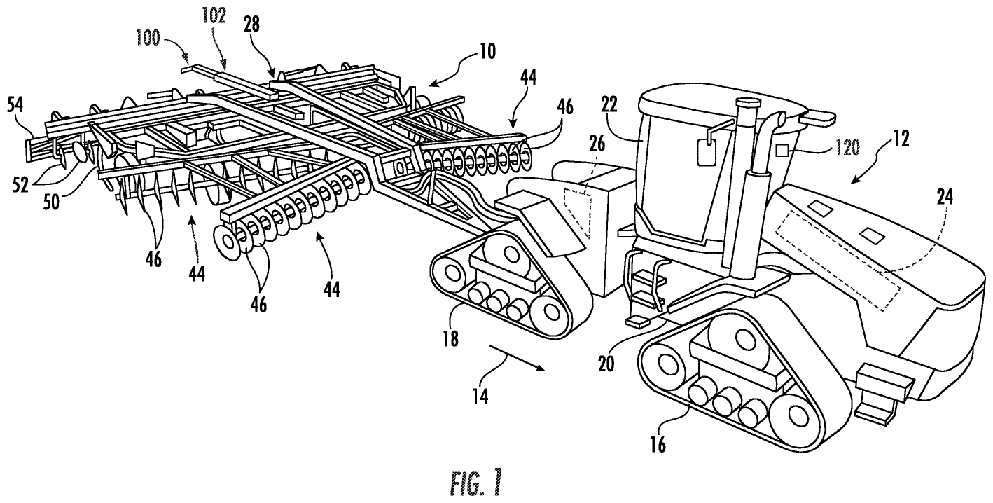

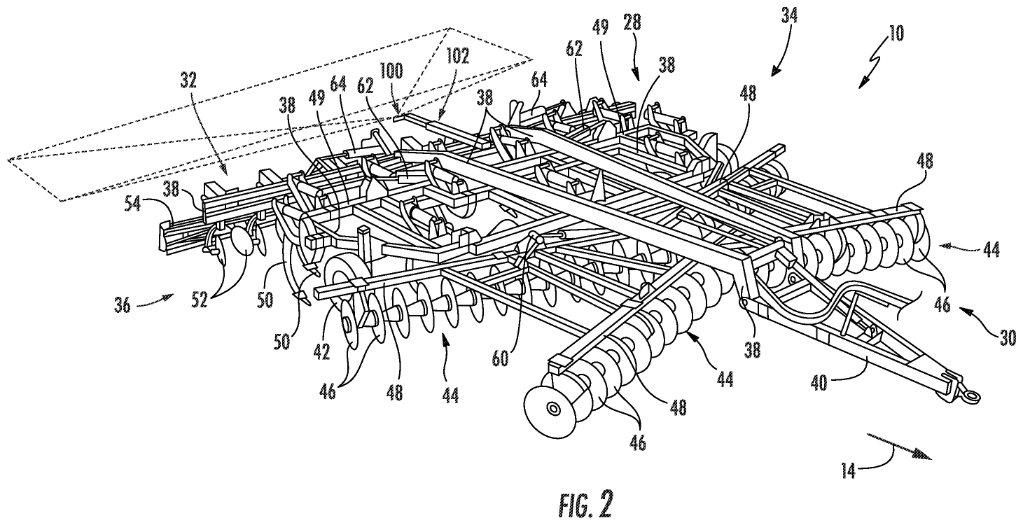

Referring now to the drawings, FIGS. 1 and 2 illustrate differing perspective views of one embodiment of an agricultural implement 10 in accordance with aspects of the present subject matter. Specifically, FIG. 1 illustrates a perspective view of the agricultural implement 10 coupled to a work vehicle 12. Additionally, FIG. 2 illustrates a perspective view of the implement 10, particularly illustrating various components of the implement 10.

In general, the implement 10 may be configured to be towed across a field in a direction of travel (e.g., as indicated by arrow 14) by the work vehicle 12. As shown, the implement 10 may be configured as a tillage implement, and the work vehicle 12 may be configured as an agricultural tractor. However, in other embodiments, the implement 10 may be configured as any other suitable type of implement, such as a seed-planting implement, a fertilizer-dispensing implement, and/or the like. Similarly, the work vehicle 12 may be configured as any other suitable type of vehicle, such as an agricultural harvester, a self-propelled sprayer, and/or the like.

As shown in FIG. 1, the work vehicle 12 may include a pair of front track assemblies 16, a pair or rear track assemblies 18, and a frame or chassis 20 coupled to and supported by the track assemblies 16, 18. An operator's cab 22 may be supported by a portion of the chassis 20 and may house various input devices (e.g., one or more user interfaces 120) for permitting an operator to control the operation of one or more components of the work vehicle 12 and/or one or more components of the implement 10. Additionally, as is generally understood, the work vehicle 12 may include an engine 24 and a transmission 26 mounted on the chassis 20. The transmission 26 may be operably coupled to the engine 24 and may provide variably adjusted gear ratios for transferring engine power to the track assemblies 16, 18 via a drive axle assembly (not shown) (or via axles if multiple drive axles are employed).

As shown in FIGS. 1 and 2, the implement 10 may include a frame 28. More specifically, as shown in FIG. 2, the frame 28 may extend longitudinally between a forward end 30 and an aft end 32. The frame 28 may also extend laterally between a first side 34 and a second side 36. In this respect, the frame 28 generally includes a plurality of structural frame members 38, such as beams, bars, and/or the like, configured to support or couple to a plurality of components. Furthermore, a hitch assembly 40 may be connected to the frame 28 and configured to couple the implement 10 to the work vehicle 12. Additionally, a plurality of wheels 42 (only one of which is shown in FIG. 2) may be coupled to the frame 28 to facilitate towing the implement 10 in the direction of travel 14.

In several embodiments, one or more ground engaging tools may be coupled to and/or supported by the frame 28. In such embodiments, the ground engaging tool(s) may, for example, include one or more ground-penetrating tools. More particularly, in certain embodiments, the ground engaging tools may include one or more disk blades 46 and/or one or more shanks 50 supported relative to the frame 28. In one embodiment, each disk blade 46 and/or shank 50 may be individually supported relative to the frame 28. Alternatively, one or more groups or sections of the ground engaging tools may be ganged together to form one or more ganged tool assemblies, such as the disk gang assemblies 44 shown in FIGS. 1 and 2.

As illustrated in FIG. 2, each disk gang assembly 44 includes a toolbar 48 coupled to the implement frame 28 and a plurality of disk blades 46 supported by the toolbar 48 relative to the implement frame 28. Each disk blade 46 may, in turn, be configured to penetrate into or otherwise engage the soil as the implement 10 is being pulled through the field. As is generally understood, the various disk gang assemblies 44 may be oriented at an angle relative to the direction of travel 14, such that an axis of rotation of the disks is not perpendicular to the direction of travel 14, to promote more effective tilling of the soil. However, it should be appreciated that the disk gang assemblies 44 may be oriented in any other suitable manner relative to the direction of travel 14. In the embodiment shown in FIGS. 1 and 2, the implement 10 includes four disk gang assemblies 44 supported on the frame 28 at a location forward of the shanks 50, adjacent to the forward end 30 of the implement 10, such as by including two forward disk gang assemblies 44 and two rear disk gang assemblies 44. However, it should be appreciated that, in alternative embodiments, the implement 10 may include any other suitable number of disk gang assemblies 44, such as more or fewer than four disk gang assemblies 44. Furthermore, in one embodiment, the disk gang assemblies 44 may be mounted to the frame 28 at any other suitable location, such as adjacent to the aft end 32 of the implement 10.

It should be appreciated that, in addition to the shanks 50 and the disk blades 46, the implement frame 28 may be configured to support any other suitable ground engaging tools. For instance, in the illustrated embodiment, the frame 28 is also configured to support a plurality of leveling blades 52 and rolling (or crumbler) basket assemblies 54.

Moreover, in several embodiments, the implement 10 may include a plurality of actuators configured to adjust the positions of the implement 10 and/or various ground engaging tools coupled thereto. For example, in some embodiments, the implement 10 may include a plurality of disk gang actuators 60 (one is shown in FIG. 2), with each actuator 60 being configured to move or otherwise adjust the orientation or position of one or more of the disk gang assemblies 44 relative to the implement frame 28. For example, a first end of each actuator 60 may be coupled to a toolbar 48 of the corresponding disk gang assembly 44, while a second end of each actuator 60 may be coupled to the frame 28. Each actuator 60 may be configured to extend and/or retract to adjust the angle of the corresponding disk gang assembly(ies) 44 relative to a lateral centerline (not shown) of the frame 28 and/or the penetration depth of the associated disk blades 46. Furthermore, each actuator 60 may be configured to extend and/or retract to adjust a downforce applied by the actuator(s) 60 to the disk gang assembly(ies) 44, and thus the disk blades 46.

Further, in some embodiments, the implement 10 may include a plurality of shank frame actuator(s) 62 (FIG. 2), with each actuator 62 being configured to move or otherwise adjust the orientation or position of one or more of the shanks 50 relative to the implement frame 28. For example, each actuator 62 may be coupled between a toolbar 49 supporting the shank(s) 50 and the implement frame 28. As such the actuator(s) 62 may be configured to extend and/or retract to adjust the position of the toolbar(s) 49 and, thus, a penetration depth of the associated shank(s) 50. Similarly, in some embodiments, the implement 10 may include a plurality of basket actuator(s) 64, with each actuator 64 being configured to move or otherwise adjust the orientation or position of one or more of the basket assemblies 54 relative to the implement frame 28. For example, each actuator 64 may be coupled between one or more of the basket assemblies 54 and the implement frame 28 and be configured to extend and/or retract to adjust an aggressiveness of the associated basket assembly (ies) 54.

In the illustrated embodiment, each actuator 60, 62, 64 corresponds to a fluid-driven actuator, such as a hydraulic or pneumatic cylinder. However, it should be appreciated that each actuator 60, 62, 64 may correspond to any other suitable type of actuator, such as an electric linear actuator. It should additionally be appreciated that the implement 10 may include any other suitable actuators for adjusting the position and/or orientation of the ground-engaging tools of the implement 10 relative to the ground and/or implement frame 28.

In accordance with aspects of the present subject matter, the implement 10 and/or the work vehicle 12 may be equipped with one or more sensors for monitoring field conditions of the field after the performance of an agricultural operation (e.g., tillage operation) with the agricultural implement 10 in the field. For instance, one or more sensors 100 may be supported on the implement 10, with the sensor(s) 100 being configured to generate data indicative of one or more field conditions of the field worked by the implement 10, where each of the field condition(s), in turn, is indicative of the performance of the implement 10. For example, the sensor(s) 100 may be configured to generate data indicative of different field condition(s) (e.g., surface profile, residue, clods, moisture, and/or the like) of the field already worked by the implement 10, which may, in turn, be used to determine at least one field condition parameter (e.g., surface roughness, surface levelness, crop residue coverage, crop residue distribution, clod sizes, clod distribution, soil compaction, moisture content, and/or the like) where the field condition parameter(s) may be used to determine the performance of the implement 10. However, it should be appreciated that the data generated by the sensor(s) 100 may be indicative of any other suitable field conditions and be used to determine any other field condition parameters indicative of the performance of the implement.

Generally, the sensor(s) 100 are supported on the implement 10 such that the sensor(s) 100 are spaced apart from and above a surface of the field during an agricultural operation with the implement 10 while having a field of view generally directed towards a portion of the field. Particularly, the field of view of each of the sensor(s) 100 is directed towards a portion of the field that has already been worked by the implement 10 during the current agricultural operation. More particularly, the field of view of the sensor(s) 100 may be directed aft of the implement 10 relative to the direction of travel 14 along a current swath being worked by the implement 10. In some instances, the sensor(s) 100 may be positioned proximate the aft end 32 of the implement 10 relative to the direction of travel 14. However, it should be appreciated that the sensor(s) 100 may instead, or additionally, be positioned at any other suitable location for generating data indicative of the performance of the implement 10. In some embodiments, the sensor(s) 100 is a LIDAR sensor(s) (e.g., a three-dimensional (3D) LIDAR sensor(s), a two-dimensional (2D) LIDAR sensor(s), and/or the like), a camera(s) (e.g., as single-spectrum camera(s) or a multi-spectrum camera(s) configured to capture images, for example, in the visible light range and/or infrared spectral range, a single lens camera(s) configured to capture two-dimensional images or a stereo camera(s) having two or more lenses with a separate image sensor for each lens to allow the camera(s) to capture stereographic or three-dimensional images, and/or the like), and/or the like.

As indicated above, the sensor(s) 100 may be unable to penetrate fully through dust, fog, rain, and/or the like. For instance, the implement 10 may generate a dust cloud trailing the implement 10 along the direction of travel 14 as the implement 10 works the field, where the field of view of each of the sensor(s) 100 may be directed towards the field aft of the implement 10, but the aft portion of the field is obscured by the trailing dust cloud. Thus, in accordance with aspects of the present subject matter, the sensor(s) 100 is selectively movable relative to the implement 10 such that the field of view of each of the sensor(s) 100 is movable along the direction of travel. For instance, the implement 10 may further include one or more sensor actuators 102 controllable to selectively actuate the sensor(s) 100 relative to the aft end 32 of the implement 10 such that the field of view of the sensor(s) 100 is movable along the direction of travel.

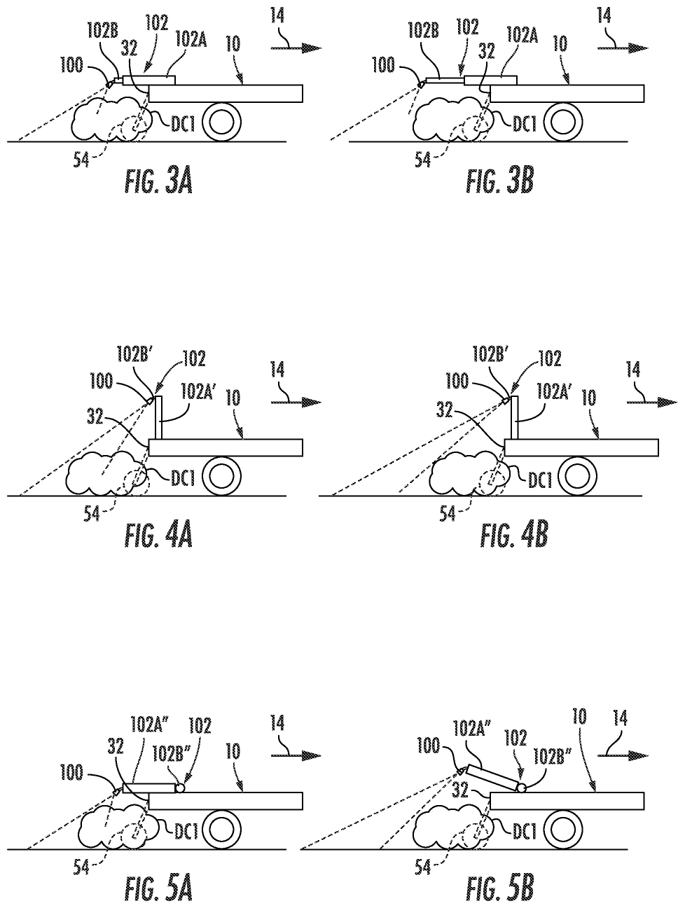

For example, referring now to FIGS. 3A-5B, various schematic, side views of the implement 10 are shown, particularly illustrating the sensor 100 being actuated between a first position and a second position to avoid a dust cloud DC1.

Particularly, as shown in FIGS. 3A and 3B, in some embodiments, the actuator(s) 102 may include a linear actuator configured to linearly actuate the sensor(s) 100 along the direction of travel 14. For instance, the actuator(s) 102 may include a base portion 102A and an extension portion 102B, with the base portion 102A being coupled to the implement 10, the extension portion 102B being movably coupled to the base portion 102A, and the extension portion 102B being supported relative to the implement 10 by the base portion 102A and fixed to the sensor(s) 100. The extension portion 102B is movable at least partially along the direction of travel 14 between a fully retracted position (FIG. 3A) and a fully extended position (FIG. 3B), spaced apart along at least the direction of travel 14. As such, the field of view of the sensor(s) 100 is movable along the direction of travel 14 between a position closest to the aft end 32 of the implement 10, associated with the fully retracted position of the extension portion 102B relative to the base portion 102A (FIG. 3A), and a position furthest from the aft end 32 of the implement 10, associated with the fully extended position of the extended portion 102B relative to the base portion 102A (FIG. 3B). It should be appreciated that, in some embodiments, the extension portion 102B moves parallel to the direction of travel 14. However, in other embodiments, the extension portion 102B moves in any other suitable orientation relative to the direction of travel 14.

Similarly, in some embodiments, such as shown in FIGS. 4A-5B the actuator(s) 102 may additionally, or alternatively, include rotary actuator(s) configured to rotate the sensor(s) 100. For instance, as shown in FIGS. 4A and 4B, the actuator(s) 102 includes a base portion 102A′ coupled at one end to the implement 10 and rotatably coupled at the other end to the sensor(s) 100 by a rotational joint 102B′ such that the sensor(s) 100 is rotatable relative to the base portion 102A′ about the rotational joint 102B′ between a first rotational position (FIG. 4A) and a second rotational position (FIG. 4B). As such, the field of view of the sensor(s) 100 is movable along the direction of travel 14 between a position closest to the aft end 32 of the implement 10, associated with the first rotational position of the sensor(s) 100 about the rotational joint 102B′ relative to the base portion 102A (FIG. 4A), and a position further from the aft end 32 of the implement 10, associated with the second rotational position of the sensor(s) 100 about the rotational joint 102B′ (FIG. 4B). In some embodiments, as shown in FIGS. 5A and 5B, the actuator(s) 102 additionally, or alternatively, include a base portion 102A″ that is rotatably coupled at one end to the implement 10 about a rotational joint 102B″ and coupled at the other end to the sensor(s) 100. The base portion 102A″ is rotatable about the rotational joint 102B″ relative to the implement 10 between a first rotational position (FIG. 5A) and a second rotational position (FIG. 5B), such that the sensor(s) 100 is moved along the direction of travel 14. As such, the field of view of the sensor(s) 100 is movable along the direction of travel 14 between a position closest to the aft end 32 of the implement 10, associated with the first rotational position of the base portion 102A″ about the rotational joint 102B″ (FIG. 5A), and a position further from the aft end 32 of the implement 10, associated with the second rotational position of the base portion 102A″ about the rotational joint 102B″ (FIG. 5B). When moving the sensor(s) 100 as shown in FIGS. 4A-5B, the angle of the field of view of the sensor(s) 100 relative to the surface of the field changes, which may be accounted for when analyzing the data generated by the sensor(s) 100.

As such, the actuator(s) 102 may be selectively controllable to move the sensor(s) 100 so that the field of view of the sensor(s) 100 may be movable relative to the aft end 32 of the implement 10 to avoid dust clouds and/or the like trailing the implement 10 to improve the data generated by the sensor(s) 100. It should be appreciated that the sensor actuator(s) 102 described in FIGS. 3A-5B may be used separately, or in any suitable combination or sub-combination thereof, to provide any suitable actuation of the sensor(s) 100. It should further be appreciated that the field of view of the sensor(s) 100 is directed towards a portion of the field at least partially aft of the rear-most ground engaging tool(s) (e.g., basket assemblies 54) when the sensor(s) 100 is in the positions shown in FIGS. 3A, 4A, 5A. In some embodiments, the field of view of the sensor(s) 100 is directed towards a portion of the field completely aft of the rear-most ground engaging tool(s) (e.g., basket assemblies 54) when the sensor(s) 100 is in the positions shown in FIGS. 3A, 4A, 5A. Additionally, it should be appreciated that the configuration of the implement 10 described above and shown in FIGS. 1-5B and the work vehicle 12 described above and shown in FIG. 1 is provided only to place the present subject matter in an exemplary field of use. Thus, it should be appreciated that the present subject matter may be readily adaptable to any manner of implement and work vehicle configuration.

Referring now to FIG. 6, a schematic view of one embodiment of a system 200 for monitoring field conditions of a field after an agricultural operation in the field is illustrated in accordance with aspects of the present subject matter. In general, the system 200 will be described herein with reference to the implement 10 described above with reference to FIGS. 1-5B and the vehicle 12 described above with reference to FIG. 1. However, it should be appreciated that the disclosed system 200 may generally be utilized with any other suitable implement/vehicle combination having any other suitable implement/vehicle configuration. Additionally, it should be appreciated that, for purposes of illustration, communicative links or electrical couplings of the system 200 shown in FIG. 6 are indicated by dashed lines.

In several embodiments, the system 200 may include a computing system 202 and various other components configured to be communicatively coupled to and/or controlled by the computing system 202, such as sensor(s) (e.g., the sensor(s) 100 configured to generate data indicative of the field conditions of a field after an agricultural operation in the field, and thus, the performance of the implement 10), actuator(s) of the implement 10 (e.g., the implement actuator(s) 60, 62, 64), drive device(s) of the vehicle 12 (e.g., the engine 24, the transmission 26, etc.), and/or a user interface(s) (e.g., user interface(s) 120). The user interface(s) 120 described herein may include, without limitation, any combination of input and/or output devices that allow an operator to provide operator inputs to the computing system 202 and/or that allow the computing system 202 to provide feedback to the operator, such as a keyboard, keypad, pointing device, buttons, knobs, touch sensitive screen, mobile device, audio input device, audio output device, and/or the like. Additionally, the computing system 202 may be communicatively coupled to one or more position sensors 122 configured to generate data indicative of the location of the implement 10 and/or the vehicle 12, such as a satellite navigation positioning device (e.g., a GPS system, a Galileo positioning system, a Global Navigation satellite system (GLONASS), a BeiDou Satellite Navigation and Positioning system, a dead reckoning device, and/or the like).

In general, the computing system 202 may correspond to any suitable processor-based device(s), such as a computing device or any combination of computing devices. Thus, as shown in FIG. 6, the computing system 202 may generally include one or more processor(s) 204 and associated memory devices 206 configured to perform a variety of computer-implemented functions (e.g., performing the methods, steps, algorithms, calculations and the like disclosed herein). As used herein, the term “processor” refers not only to integrated circuits referred to in the art as being included in a computer, but also refers to a controller, a microcontroller, a microcomputer, a programmable logic controller (PLC), an application specific integrated circuit, and other programmable circuits. Additionally, the memory 206 may generally comprise memory element(s) including, but not limited to, computer readable medium (e.g., random access memory (RAM)), computer readable non-volatile medium (e.g., a flash memory), a floppy disk, a compact disc-read only memory (CD-ROM), a magneto-optical disk (MOD), a digital versatile disc (DVD) and/or other suitable memory elements. Such memory 206 may generally be configured to store information accessible to the processor(s) 204, including data 208 that can be retrieved, manipulated, created and/or stored by the processor(s) 204 and instructions 210 that can be executed by the processor(s) 204.

It should be appreciated that the computing system 202 may correspond to an existing computing device for the implement 10 or the vehicle 12 or may correspond to a separate processing device. For instance, in one embodiment, the computing system 202 may form all or part of a separate plug-in module that may be installed in operative association with the implement 10 or the vehicle 12 to allow for the disclosed system and method to be implemented without requiring additional software to be uploaded onto existing control devices of the implement 10 or the vehicle 12.

In several embodiments, the data 208 may be stored in one or more databases. For example, the memory 206 may include a sensor database 212 for storing data generated by the sensors 100, 122. For instance, the sensor(s) 100 may be configured to continuously or periodically generate data associated with a portion of the field, such as during the performance of the agricultural operation with the implement 10. Further, the data from the sensor(s) 100 may be taken with reference to the position of the sensor(s) 100 relative to the implement 10 (e.g., the position of the actuator(s) 102) to account for changes in the angle of the field of view of the sensor(s) 100 relative to the surface of the field as the sensor(s) 100 are moved by the actuator(s) 102. Similarly, the data from the sensor(s) 100 may be taken with reference to the position of the implement 10 and/or the vehicle 12 within the field based on the position data from the position sensor(s) 122. The data transmitted to the computing system 202 from the sensors 100, 122 may be stored within the sensor database 212 for subsequent processing and/or analysis. It should be appreciated that, as used herein, the term “sensor data 212” may include any suitable type of data received from the sensors 100, 122 that allows for the performance of the implement to be determined. For instance, the data generated by the sensor(s) 100 may include image data, reflectance data (e.g., as a point-cloud), and/or any other suitable type of data, indicative of one or more monitored field conditions, and the data generated by the position sensor(s) 122 may include GPS coordinates, and/or any other suitable type of data.

The instructions 210 stored within the memory 206 of the computing system 202 may be executed by the processor(s) 204 to implement a performance module 218. In general, the performance module 218 may be configured to assess the sensor data 212 deriving from the sensors 100, 122 to determine the performance of the implement 10 during an agricultural operation with the implement 10 within a field. For instance, the performance module 218 may be configured to assess the sensor data 212 deriving from the sensors 100, 122 to determine one or more field conditions (e.g., surface profile, residue, clods, moisture, and/or the like) and one or more parameters of such field condition(s) (e.g., surface roughness, surface levelness, residue coverage, residue distribution, clod distribution, clod size, soil compaction, moisture content, and/or the like) across the field, where the field condition(s), particularly the parameter of the field condition(s), is indicative of the performance of the implement 10.

The performance module 218 may further be configured to assess the quality of the sensor data 212 deriving from the sensor(s) 100 to determine when the aft portion of the field within the field of view of the sensor(s) 100 is obscured to the sensor(s) 100 (e.g., by a dust cloud and/or the like between the sensor(s) 100 and the field surface). For instance, the performance module 218 may be configured to analyze the sensor data 212 generated by the sensor(s) 100, e.g., using one or more data analysis or processing techniques, algorithms, and/or the like stored within the memory, to automatically determine when the aft portion of the field within the field of view of the sensor(s) 100 is obscured to the sensor(s) 100. For example, the performance module 218 may analyze the images from the sensor data 212 generated by the sensor(s) 100, when the sensor(s) 100 include imaging devices (e.g., camera(s)), using any suitable image processing techniques. Suitable processing or analyzing techniques may include performing spatial analysis on received images or image data. For instance, geometric or spatial processing algorithms, shape detection and/or edge-finding or perimeter-finding algorithms, and/or the like may differentiate the shape, color, edges, and/or the like of a dust cloud from expected field features (e.g., residue, soil, rocks, and/or the like) in the images. Similar processing techniques may be used by the performance module 218 when the sensor(s) 100 include LIDAR sensors to analyze point clouds generated from the sensor data 212.

However, in one embodiment, the performance module 218 may be configured to control an operation of the user interface(s) 120 to display or otherwise indicate the data generated by the sensor(s) 100 and, in response, receive an indication from an operator when the aft portion of the field within the field of view of the sensor(s) 100 is obscured to the sensor(s) 100. For instance, an operator may monitor the data displayed via the user interface(s) 120 and indicate (e.g., via the user interface(s) 120) when the aft portion of the field within the field of view of the sensor(s) 100 is obscured to the sensor(s) 100 (e.g., by a dust cloud, fog, and/or the like).

The instructions 210 stored within the memory 206 of the computing system 202 may also be executed by the processor(s) 204 to implement a control module 220. For instance, the control module 220 may be configured to initiate or perform a control action based on the quality of the data generated by the sensor(s) 100. For example, in some embodiments, when it is determined that quality of the data generated by the sensor(s) 100 is low because the portion of the field within the field of view of the sensor(s) 100 is obscured to the sensor(s) 100 (e.g., by a cloud, fog, and/or the like), the control module 220 may perform a control action to control an operation of the user interface(s) 120 to indicate to an operator that the field of view of the sensor(s) 100 is obscured to the sensor(s) 100. In some embodiments, the control module 220 may be further configured to request that the operator adjust the position of the sensor(s) 100 (e.g., by the operator controlling the operation of the actuator(s) 102 and/or by inputting which direction the sensor(s) 100 should be moved).

In some embodiments, when it is determined that the quality of the data generated by the sensor(s) 100 is low because the portion of the field within the field of view of the sensor(s) 100 is obscured to the sensor(s) 100 (e.g., by a cloud, fog, and/or the like), the control module 220 may perform a control action to move the field of view of the sensor(s) 100 away from the obscured portion of the field.

Suitable control actions may include automatically controlling the operation of one or more of the sensor actuator(s) 102 to move the sensor(s) 100 and, thus, the field of view of the sensor(s) 100, away from the obscured portion of the field. For example, the control module 220 may control the operation of the sensor actuator(s) 102 to move the sensor(s) 100 such that the field of view of the sensor(s) 100 moves further aft of the implement 10 along the direction of travel (e.g., towards the position shown in FIGS. 3B, 4B, 5B). It should be appreciated that, in some instances, the control module 220 may be further configured to determine the direction to move the sensor(s) 100 based at least in part on the data generated by the sensor(s) 100. For instance, if the data generated by the sensor(s) 100 indicates an end of a dust cloud along the direction of travel 14 (e.g., the rear end of the dust cloud DC1 in FIGS. 3A, 4A, 5A along the direction of travel 14), the control module 220 may be configured to control the actuator(s) 102 to move the sensor(s) 100 such that the field of view of the sensor(s) 100 moves in the direction towards the end of the dust cloud (e.g., rearward along the direction of travel 14). Similarly, if the data generated by the sensor(s) 100 indicates the height and/or height range of the obstruction above a surface of the field, the control module 220 may control the actuator(s) 102 according to the height and/or height range of the obstruction to move the sensor(s) 100 such that the field of view of the sensor(s) 100 passes above or below the obstruction. If the data generated by the sensor(s) 100 indicates the density of the obstruction (e.g., dust cloud), the control module 220 may control the actuator(s) 102 according to the density of the obstruction. For example, if the obstruction is very dense within the field of view of the sensor(s) 100, the sensor(s) 100 may need to be moved further along the direction of travel 14 than if the obstruction is less dense. Additionally, or alternatively, if the data generated by the sensor(s) 100 indicates a direction of wind, the control module 220 may be configured to control the operation of the actuator(s) 102 to move the sensor(s) 100 according to the direction of the wind (e.g., upwind) to better avoid the obstruction.

If the portion of the field within the field of view further aft of the implement 10 along the direction of travel is still determined to be obscured, the control module 220 may further control the operation of the sensor actuator(s) 102 to move the sensor(s) 100 such that the field of view of the sensor(s) 100 moves even further aft of the implement 10 along the direction of travel (e.g., closer to the position shown in FIGS. 3B, 4B, 5B), if possible. Alternatively, in some instances, if the field of view further aft of the implement 10 is still determined to be obscured, the control module 220 may determine that fog may be present in the field and control the operation of the sensor actuator(s) 102 to lower the sensor(s) 100 along the vertical direction (e.g., by rotating the base portion 102A″ about the rotational joint 102B″ towards or beyond the position shown in FIG. 5A), if possible, such that the sensor(s) 100 are moved vertically closer to the field and potentially vertically below a fog layer. In one embodiment, if the portion of the field within the field of view further aft of the implement 10 along the direction of travel is still determined to be obscured, the control module 220 may additionally, or alternatively, control the operation of the user interface(s) 120 to indicate that the field of view is still obscured.

Moreover, the control module 220 may be configured to initiate or perform a control action based on the monitored field conditions. For instance, the control module 220 may be configured to monitor the field condition(s) determined based on the data generated by the sensor(s) 100 relative to desired or predetermined parameter(s) of the monitored field condition(s). The desired parameter(s) of the monitored field condition(s) may be input by an operator via the user interface(s) 120, predetermined based on a tillage prescription map uploaded and stored in the memory 206, or received/accessible in any other suitable manner. The control module 220 may initiate or perform a control action when the monitored parameter(s) of the field condition(s) differs by or is outside of a given threshold from the desired field condition parameter(s) of the monitored field condition(s). In some instances, the control module 220 only initiates the control action when the quality of the sensor data 212 is above a particular threshold and/or indicates that the aft portion of the field is not obscured to the sensor(s) 100 by a dust cloud, and/or the like. The control action, in one embodiment, includes adjusting the operation of one or more components of the implement 10, such as adjusting the operation of one or more of the actuators 60, 62, 64 to adjust the penetration depth of the ground engaging tool(s) 46, 50, 52, 54 and/or adjust the operation of one or more of the drive device(s) 24, 26 to adjust a ground speed of the implement 10 and/or the vehicle 12 based on the monitored parameter(s) (e.g., surface roughness, surface levelness, residue coverage, residue size, clod distribution, clod size, soil compaction, moisture content, etc.) of the monitored field condition(s) to improve performance of the implement 10. In some embodiments, the control action may include controlling the operation of the user interface 120 to notify an operator of the performance (e.g., the monitored field condition parameter(s)) and/or the like. Additionally, or alternatively, in some embodiments, the control action may include adjusting the operation of the implement 10 based on an input from an operator, e.g., via the user interface 120.

Additionally, as shown in FIG. 6, the computing system 202 may also include a communications interface 222 to provide a means for the computing system 202 to communicate with any of the various other system components described herein. For instance, one or more communicative links or interfaces (e.g., one or more data buses) may be provided between the communications interface 222 and the sensor(s) 100, 122 to allow data transmitted from the sensor(s) 100, 122 to be received by the computing system 202. Similarly, one or more communicative links or interfaces (e.g., one or more data buses) may be provided between the communications interface 222 and the user interface 120 to allow operator inputs to be received by the computing system 202 and to allow the computing system 202 to control the operation of one or more components of the user interface 120. Moreover, one or more communicative links or interfaces (e.g., one or more data buses) may be provided between the communications interface 222 and the implement actuator(s) 60, 62, 64 and/or the drive device(s) 24, 26 to allow the computing system 202 to control the operation of one or more components of the implement actuator(s) 60, 62, 64 and/or the drive device(s) 24, 26.

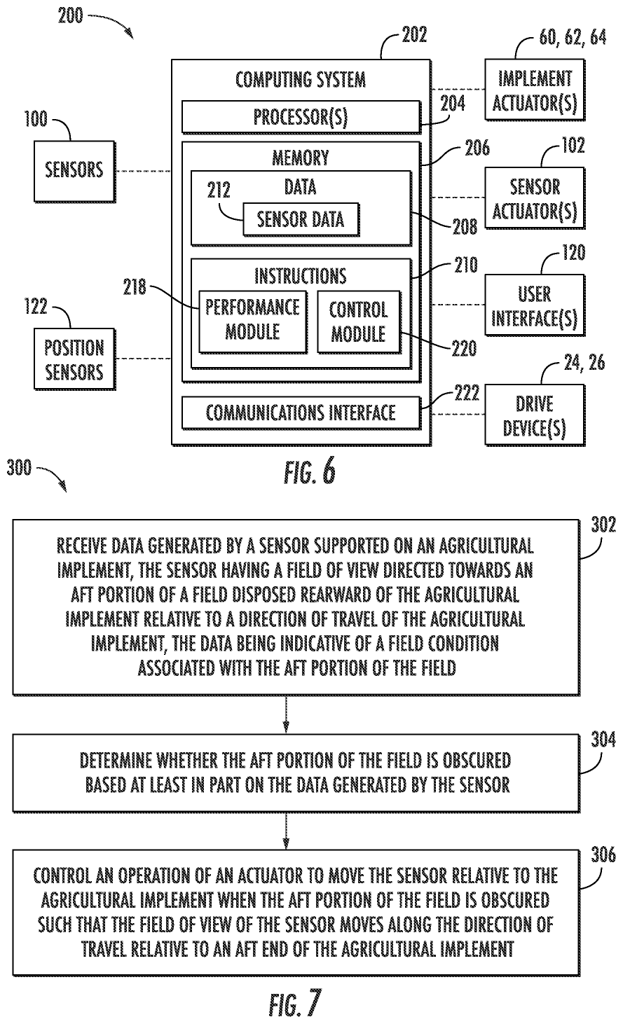

Referring now to FIG. 7, a flow diagram of one embodiment of a method 300 for monitoring field conditions of a field after an agricultural operation in the field is illustrated in accordance with aspects of the present subject matter. In general, the method 300 will be described herein with reference to the implement 10 described with reference to FIGS. 1-5B, the work vehicle 12 described with reference to FIG. 1, as well as the various system components shown in FIG. 6. However, it should be appreciated that the disclosed method 300 may be implemented with work vehicles and/or implements having any other suitable configurations, and/or within systems having any other suitable system configurations. In addition, although FIG. 7 depicts steps performed in a particular order for purposes of illustration and discussion, the methods discussed herein are not limited to any particular order or arrangement. One skilled in the art, using the disclosures provided herein, will appreciate that various steps of the methods disclosed herein can be omitted, rearranged, combined, and/or adapted in various ways without deviating from the scope of the present disclosure.

As shown in FIG. 7, at (302), the method 300 may include receiving data generated by a sensor supported on an agricultural implement, the sensor having a field of view directed towards an aft portion of a field disposed rearward of the agricultural implement relative to a direction of travel of the agricultural implement, and the data being indicative of a field condition associated with the aft portion of the field. For instance, as described above, the computing system 202 may be configured to receive data generated by the sensor(s) supported on the agricultural implement 10, where the sensor(s) 100 has a field of view directed towards an aft portion of the field disposed rearward of the agricultural implement 10 relative to a forward direction of travel 14 of the agricultural implement 10, and where the data generated by the sensor(s) 100 is indicative of a field condition associated with the aft portion of the field.

Further, at (304), the method 300 may include determining whether the aft portion of the field is obscured based at least in part on the data generated by the sensor. For example, as discussed above, the computing system 202 may be configured to determine whether the aft portion of the field is obscured to the sensor(s) 100 (e.g., by a dust cloud, fog, and/or the like) based at least in part on the data generated by the sensor(s) 100.

Additionally, at (306), the method 300 may include controlling an operation of an actuator to move the sensor relative to the agricultural implement when the aft portion of the field is obscured such that the field of view of the sensor moves along the direction of travel relative to an aft end of the agricultural implement. For instance, as discussed above, the computing system 202 may be configured to control an operation of the sensor actuator(s) 102 to move the sensor(s) 100 relative to the agricultural implement 10 when the aft portion of the field is obscured such that the field of view of the sensor(s) 100 moves along the direction of travel 14 relative to the aft end 32 of the agricultural implement 10.

It is to be understood that the steps of the method 300 are performed by the computing system 200 upon loading and executing software code or instructions which are tangibly stored on a tangible computer readable medium, such as on a magnetic medium, e.g., a computer hard drive, an optical medium, e.g., an optical disk, solid-state memory, e.g., flash memory, or other storage media known in the art. Thus, any of the functionality performed by the computing system 200 described herein, such as the method 300, is implemented in software code or instructions which are tangibly stored on a tangible computer readable medium. The computing system 200 loads the software code or instructions via a direct interface with the computer readable medium or via a wired and/or wireless network. Upon loading and executing such software code or instructions by the computing system 200, the computing system 200 may perform any of the functionality of the computing system 200 described herein, including any steps of the method 300 described herein.

The term “software code” or “code” used herein refers to any instructions or set of instructions that influence the operation of a computer or computing system. They may exist in a computer-executable form, such as machine code, which is the set of instructions and data directly executed by a computer's central processing unit or by a computing system, a human-understandable form, such as source code, which may be compiled in order to be executed by a computer's central processing unit or by a computing system, or an intermediate form, such as object code, which is produced by a compiler. As used herein, the term “software code” or “code” also includes any human-understandable computer instructions or set of instructions, e.g., a script, that may be executed on the fly with the aid of an interpreter executed by a computer's central processing unit or by a computing system.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. An agricultural system for monitoring field conditions of a field after an agricultural operation in the field, the agricultural system comprising:
an agricultural implement comprising a frame and ground-engaging tools supported on the frame, the ground-engaging tools being configured to engage a field during an agricultural operation:
a sensor supported on the agricultural implement, the sensor having a field of view directed towards an aft portion of the field disposed rearward of the agricultural implement relative to a direction of travel of the agricultural implement, the sensor being configured to generate data indicative of a field condition associated with the aft portion of the field; and
an actuator configured to selectively move the sensor relative to the agricultural implement such that the field of view of the sensor moves along the direction of travel relative to an aft end of the agricultural implement.

2. The agricultural system of claim 1, further comprising a computing system communicatively coupled to the sensor and the actuator, the computing system being configured to:
receive the data generated by the sensor:
determine whether the aft portion of the field is obscured based at least in part on the data generated by the sensor; and
perform a control action when the aft portion of the field is obscured.

3. The agricultural system of claim 2, wherein the computing system is configured to determine whether the aft portion of the field is obscured by performing data analysis on the data generated by the sensor.

4. The agricultural system of claim 2, wherein the control action comprises controlling an operation of a user interface to indicate that the aft portion of the field is obscured.

5. The agricultural system of claim 4, wherein the computing system is further configured to:
receive an input from an operator via the user interface indicative of moving the sensor; and
control an operation of the actuator to move the sensor such that the field of view of the sensor is moved relative to the aft end of the agricultural implement based at least in part on the input received via the user interface.

6. The agricultural system of claim 2, wherein the control action comprises automatically controlling an operation of the actuator to move the sensor such that the field of view of the sensor is moved relative to the aft end of the agricultural implement.

7. The agricultural system of claim 6, wherein the computing system is further configured to determine at least one of a height of dust above a surface of the field, a density of the dust, or a direction of wind based at least in part on the data,
wherein controlling the operation of the actuator to move the sensor comprises controlling the operation of the actuator to move the sensor based at least in part on the at least one of the height of the dust, the density of the dust, or the direction of wind.

8. The agricultural system of claim 2, wherein the computing system is further configured to:
determine the field condition associated with the aft portion of the field based on the data received from the sensor when the aft portion of the field is determined to not be obscured; and
control an operation of the agricultural implement based at least in part on the field condition.

9. The agricultural system of claim 1, wherein the actuator comprises at least one actuator, the at least one actuator being configured to at least one of linearly actuate the sensor along the direction of travel relative to the aft end of the agricultural implement or rotatably actuate the sensor relative to the aft end of the agricultural implement such that the field of view of the sensor moves along the direction of travel relative to the aft end of the agricultural implement.

10. The agricultural system of claim 1, wherein the sensor is a LIDAR sensor or a camera.

11. An agricultural method for monitoring field conditions of a field after an agricultural operation with an agricultural implement in the field, the agricultural implement comprising a frame and ground-engaging tools supported on the frame, the ground-engaging tools being configured to engage a field during the agricultural operation, the agricultural method comprising:
receiving, with a computing system, data generated by a sensor supported on the agricultural implement, the sensor having a field of view directed towards an aft portion of the field disposed rearward of the agricultural implement relative to a direction of travel of the agricultural implement, the data being indicative of a field condition associated with the aft portion of the field:
determining, with the computing system, whether the aft portion of the field is obscured based at least in part on the data generated by the sensor; and
controlling, with the computing system, an operation of an actuator to move the sensor relative to the agricultural implement when the aft portion of the field is obscured such that the field of view of the sensor moves along the direction of travel relative to an aft end of the agricultural implement.

12. The agricultural method of claim 11, wherein determining whether the aft portion of the field is obscured comprises:
controlling, with the computing system, an operation of a user interface to display the data generated by the sensor; and
receiving, with the computing system, an input from an operator via the user interface indicative of the aft portion of the field being obscured.

13. The agricultural method of claim 11, further comprising determining, with the computing system, at least one of a height of dust above a surface of the field, a density of the dust, or a direction of wind based at least in part on the data,
wherein controlling the operation of the actuator to move the sensor comprises controlling the operation of the actuator to move the sensor based at least in part on the at least one of the height of the dust, the density of the dust, or the direction of wind.

14. The agricultural method of claim 11, wherein determining whether the aft portion of the field is obscured comprises performing, with the computing system, data analysis of the data generated by the sensor.

15. The agricultural method of claim 14, further comprising:
controlling, with the computing system, an operation of a user interface to indicate that the aft portion of the field is obscured; and
receiving, with the computing system, an input from an operator via the user interface indicative of moving the sensor,
wherein controlling the operation of the actuator to move the sensor comprises controlling the operation of the actuator to move the sensor such that the field of view of the sensor is moved relative to the aft end of the agricultural implement based at least in part on the input received via the user interface.

16. The agricultural method of claim 11, further comprising:
determining, with the computing system, the field condition associated with the aft portion of the field based on the data received from the sensor when the aft portion of the field is determined to not be obscured; and
controlling, with the computing system, an operation of the agricultural implement based at least in part on the field condition.

17. The agricultural method of claim 16, wherein the field condition comprises at least one of a surface roughness, a surface levelness, a clod size, a residue coverage, soil compaction, or moisture content.

18. The agricultural method of claim 11, wherein controlling the operation of the actuator to move the sensor comprises controlling the operation of the actuator to at least one of linearly or rotatably actuate the sensor relative to the aft end of the agricultural implement such that the field of view of the sensor moves along the direction of travel relative to the aft end of the agricultural implement.

19. The agricultural method of claim 11, wherein controlling the operation of the actuator to move the sensor comprises automatically controlling the operation of the actuator to move the sensor.

20. The agricultural method of claim 11, wherein the sensor is a LIDAR sensor or a camera.
